(19) United States
(12) Patent Application Publication
(10) Pub. No.: US 2026/0352437 A1
(43) Pub. Date: Nov. 5, 2026

(54) RECEIVER CIRCUIT WITH MATCHED-DELAY STRUCTURE

(71) Applicant: TAIWAN SEMICONDUCTOR MANUFACTURING COMPANY LTD., HSINCHU (TW)

(72) Inventors: YU-JIE HUANG, KAOHSIUNG CITY (TW); MU-SHAN LIN, HSINCHU CITY (TW)

(21) Appl. No.: 19/194,054

(22) Filed: Apr. 30, 2025

(51) Int. Cl. H04L 7/00

(52) U.S. Cl. CPC H04L 7/0079; H04L 7/0008

(57) ABSTRACT

A receiver circuit is provided, which includes a clock calibration circuit, an amplifier, a delay chain, and a deserializer. The clock calibration circuit receives a first input clock signal and a second input clock signal in opposite phases, converts the first input clock signal to a first clock signal and a second clock signal, and converts the second input clock signal to a third clock signal and a fourth clock signal. The amplifier amplifies a serial data signal. The delay chain delays the amplified serial data signal to generate a delayed data signal. A set of sense-amplifier flip-flops of the deserializer latches the delayed data signal to generate a set of latched data signals in response to rising edges of the first to fourth clock signals. A demultiplexer of the deserializer demultiplexes the set of latched data signals to generate a parallel data signal.

### BACKGROUND

The current trend in miniaturizing integrated circuits (ICs) has led to the development of smaller, more efficient devices with increased functionality and higher operating speeds. This miniaturization process has also brought about more stringent design and manufacturing requirements, as well as reliability challenges. Electronic design automation (EDA) tools are utilized to create, optimize, and validate standard cell layout designs for integrated circuits, ensuring that they meet both design and manufacturing specifications.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of a communication system in accordance with some embodiments of the present disclosure.

FIG. 2 is a block diagram of a semiconductor die with a plurality of receiver devices in accordance with some embodiments.

FIG. 3A is a schematic diagram of a deskew circuit in accordance with some embodiments.

FIG. 3B is a diagram illustrating a portion of the deskew circuit in FIG. 3A.

FIG. 3C is a circuit diagram of an inverter stage 330 in FIG. 3B.

FIG. 4A is a schematic diagram of a deskew circuit in accordance with some embodiments of the present disclosure.

FIG. 4B is a schematic diagram of another deskew circuit in accordance with some embodiments of the present disclosure.

FIG. 4C illustrates a circuit diagram of a switch-controlled buffer in FIG. 4A.

FIG. 4D is a circuit diagram of a switch-controlled inverter in FIG. 4B.

FIG. 5A is a circuit diagram of a clock tree in accordance with some embodiments.

FIG. 5B is a circuit diagram of portion 520 in the clock tree 500 in FIG. 5A.

FIG. 6A is a diagram illustrating distribution of a clock tree in accordance with some embodiments.

FIG. 6B is a schematic diagram illustrating a first configuration of the clock tree in FIG. 6A.

FIG. 6C is a schematic diagram illustrating a second configuration of the clock tree in FIG. 6A.

FIG. 7 is flowchart of a method for operating a receiver device in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

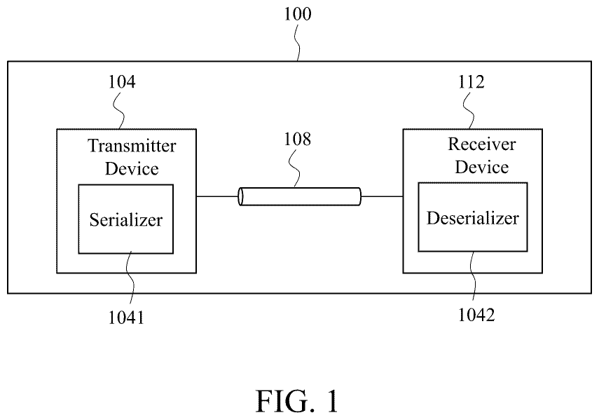

FIG. 1 is a block diagram of a communication system in accordance with some embodiments of the present disclosure.

In some embodiments, the communication system 100 may include a transmitter device 104 and a receiver circuit 112. The transmitter device 104 is communicatively coupled to the receiver circuit 112 via a communication channel 108. The transmitter device 104 is configured to send one or more signals to the receiver circuit 112 through the communication channel 108. The communication channel 108 may be a physical transmission medium, such as a backplane, drive head in a magnetic recording system, copper cables, optical fibers, one or more coaxial cables, and/or wire, or the communication channel 108 may include a one or more radio frequency (RF) channels. Although described herein as being utilized in a communication system 100, examples of the present disclosure are not so limited, and some examples might be employed in alternative communications systems utilizing a transmitter and a receiver communicating over a communication channel. Moreover, it is understood that each “bit” of a signal has a corresponding logic value and that various signals described herein may utilize multi-bit data symbols based on various data encoding schemes, such as pulse amplitude modulation (e.g., PAM-4).

In some embodiments, the transmitter device 104 may include a serializer 1041 configured to convert a plurality of bits of a parallel input data signal to a serial data signal. Additionally, the receiver circuit 112 may include a deserializer 1042 configured to convert a serial data signal to a parallel data signal. For example, the serializer 1041 may send the serial data signal, which is converted from a parallel input data signal, to the deserializer 1042 through the communication channel 108. Accordingly, the communication system 100 can also be regarded as a SerDes (serializer/deserializer) communication system.

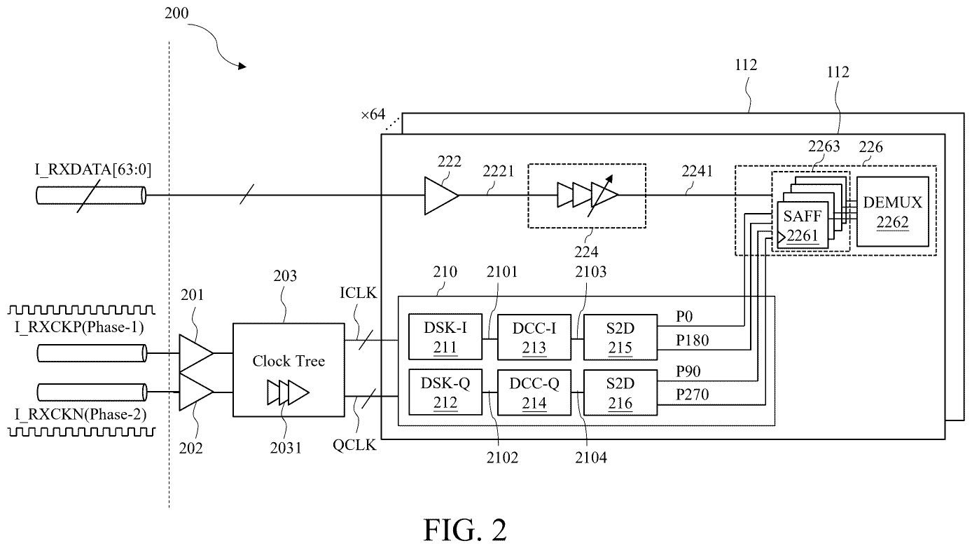

In some embodiments, the transmitter device 104 and the receiver circuit 112 may be disposed on first die and a second die (both not shown), respectively, while the communication channel 108 may be a physical data lane between the first die and the second die. In some embodiments, there may be a plurality of communication channels 108 (e.g., lanes) between the transmitter device 104 and the receiver circuit 112, and the plurality of communication channels 108 include at least 2 clock lanes (e.g., for two clock signals with opposite phases) and 64 data lanes (×64) defined by the UCIe (Universal Chiplet Interconnect Express) 1.0 protocol or a later revisions. Further details thereof will be described with reference to FIG. 2.

FIG. 2 is a block diagram of a semiconductor die with a plurality of receiver devices in accordance with some embodiments.

In some embodiments, semiconductor die 200 is configured to receive a data signal I_RXDATA[63:0], a first clock signal I_RXCLKP, and a second clock signal I_RXCKN from a transmitter device on another semiconductor die (not shown) through respective lanes or communication channels. The first clock signal I_RXCLKP and the second clock signal I_RXCKN have opposite phases. In some embodiments, the first clock signal I_RXCLKP is an in-phase clock signal, while the second clock signal is a quadrature clock signal, indicating that the first clock signal I_RXCLKP and the second clock signal I_RXCLKN have opposite phases. In some embodiments, the data signal I_RXDATA[63:0] is a serial data signal generated by the serializer 1041 of the transmitter device 104 shown in FIG. 1.

In some embodiments, semiconductor die 200 includes a plurality of receiver circuits 112, such as 64 receiver circuits 112. Each of the receiver circuits 112 is configured to receive a respective data bit I_RXDATA[0] to I_RXDATA[63] of the data signal I_RXDATA[63:0]. In some embodiments, the first clock signal I_RXCLKP and the second clock signal I_RXCLKN are amplified by amplifiers 201 and 202, respectively. The clock tree 203 includes a plurality of clock buffers 2031, which are arranged in a plurality of stages, to drive and distribute the amplified first clock signal I_RXCLKP and the amplified second clock signal I_RXCLKN to a plurality of clock leaves (e.g., 64 leaves for each of the amplified first clock signal I_RXCLKP and the amplified second clock signal I_RXCLKN). Accordingly, the amplified first clock signal I_RXCLKP and the amplified second clock signal I_RXCLKN may serve as an in-phase clock signal ICLK and a quadrature clock signal QCLK for each receiver circuit 112 at each clock leave of clock tree 203, respectively. It should be noted that the components within one of the receiver circuit 112 is shown in FIG. 2 for simplicity and illustrative purposes.

Additionally, each of the receiver circuits 112 is further configured to receive an in-phase clock signal ICLK and a quadrature clock signal QCLK distributed by the clock tree 203. It should be noted that due to the variations of communication channels for the clock signals I_RXCKP and I_RXCKN and different clock distribution routings in the clock tree 203, a delay may exist between the in-phase clock signal ICLK and the quadrature clock signal QCLK received by each of the receiver circuit 112, and the duties of the in-phase clock signal ICLK and quadrature clock signal QCLK may be not equal to 50%. The aforementioned delay between the in-phase clock signal ICLK and the quadrature clock signal QCLK received by each of the receiver circuit 112 and the duties of the in-phase clock signal ICLK and quadrature clock signal QCLK can be calibrated by the clock calibration circuit 210 within each receiver circuit 112.

In some embodiments, the clock calibration circuit 210 within each receiver circuit 112 includes a deskew circuit 211 (e.g., DSK-I), a deskew circuit (e.g., DSK-Q) 212, a duty cycle corrector (e.g., DCC-I) 213, a duty cycle corrector (e.g., DCC-Q) 214, and single-to-differential (S2D) circuits 215 and 216. In some embodiments, the deskew circuits 211 and 212 are configured to align the starting edges of each cycle of the in-phase clock signal ICLK and the quadrature clock signal QCLK, such as aligning the rising edge of the in-phase clock signal ICLK and the falling edge of the quadrature clock signal QCLK.

In some embodiments, the duty cycle corrector 213 is configured to correct the duty of the deskewed in-phase clock signal ICLK (e.g., signal 2101) to a predetermined duty, such as 50%, to generate a duty-corrected in-phase clock signal ICLK (e.g., signal 2103). The duty cycle corrector 214 is configured to correct the duty of the deskewed quadrature clock signal QCLK (e.g., signal 2102) to a predetermined duty, such as 50%, to generate a duty-corrected quadrature clock signal QCLK (e.g., signal 2104).

In some embodiments, the S2D circuit 215 is configured to convert the duty-corrected in-phase clock signal ICLK (e.g., signal 2103) to a first clock signal P0 and a second clock signal P180 with opposite phases. The S2D circuit 216 is configured to convert the duty-corrected quadrature clock signal QCLK (e.g., signal 2104) to a third clock signal P90 and a fourth clock signal P270 with opposite phases. Additionally, the first clock signal P0, the second clock signal P180, the third clock signal P90, and the fourth clock signal P270 have phases of 0 degrees, 180 degrees, 90 degrees, and 270 degrees, respectively. Furthermore, the first clock signal P0, the second clock signal P180, the third clock signal P90, and the fourth clock signal P270 are provided to the respective sense-amplifiers flip-flops (SAFF) 2261 (e.g., D flip-flops) within the SAFF set 2263 in the deserializer 226, wherein four SAFFs 2261 are shown for illustrative purposes.

In some embodiments, the amplifier 222 within each receiver circuit 112 is configured to amplify the respective bit of the data signal I_RXDATA[63:0] received by each receiver circuit 112 to generate an amplified data signal 2221, which is sent to the delay chain 224.

In some embodiments, the delay chain 224 is implemented using a multiple-stage inverter delay chain with a digitally controlled delay line (DCDL). The delay chain 224 is configured to change the delay of the amplified data signal 2221 to generate a delayed data signal 2241, which is sent to all of the SAFFs 2261 within the SAFF set 2263. In some embodiments, the structure of semiconductor die 200 shown in FIG. 2 is a matched-delay RX structure. The delay added to the amplified data signal 2221 along the data path substantially matches that of the clock path (e.g., from amplifier 201-202 to the SAFF set 2263 through clock tree 203 and clock calibration circuit 210).

In some embodiments, the deserializer 226 includes an SAFF set 2263 and a demultiplexer (DEMUX) 2262. The SAFF set 2263 includes a plurality of SAFFs 2261, each SAFF 2261 being triggered by rising edges of respective clock signals P0, P90, P180, and P270 generated by the S2D circuits 215 and 216, thereby latching the delayed data signal 2241 at the rising edges of the clock signals of different phases using a 4-time frequency of the clock signals I_RXCKP and I_RXCKN. In some embodiments, the demultiplexer 2262 is a 4-to-8 demultiplexer operating in conjunction with the four SAFFs 2261, enabling the deserializer 226 to perform 1:2 demultiplexing or deserializing to generate a parallel data signal. In some embodiments, the demultiplexer 2262 can support a larger demultiplexing ratio, thereby achieving a higher demultiplexing rate of the deserializer 226.

It should be noted that no deskew circuit is disposed along the data path in each receiver circuit 112 for aligning the timing of data bits of the input data signal I_RXDATA[63:0], thus reducing power consumption of the data path compared to some approaches employing deskew circuits along the data path in each receiver. Additionally, no quadrature error corrector (QEC) is disposed along each clock path in each receiver circuit 112, and the deskew circuits 211 and 212 along each clock path in each receiver circuit 112 (e.g., lane-based) can enable both the functions of quadrature error correction and deskewing along each clock path operating at half frequency of the data path, significantly reducing the power consumption of each receiver circuit 112. Moreover, the number of stages within the deskew circuits 211 and 212 can be reduced, thereby reducing the latency along each clock path. As such, the number of inverters in the delay chain 224 can be reduced as well using the structure of semiconductor die 200 shown in FIG. 2.

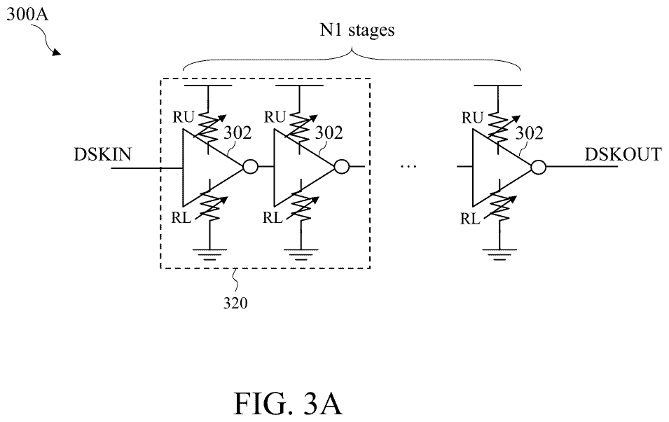

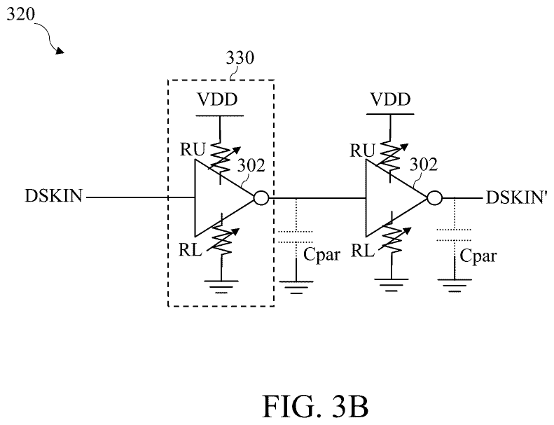

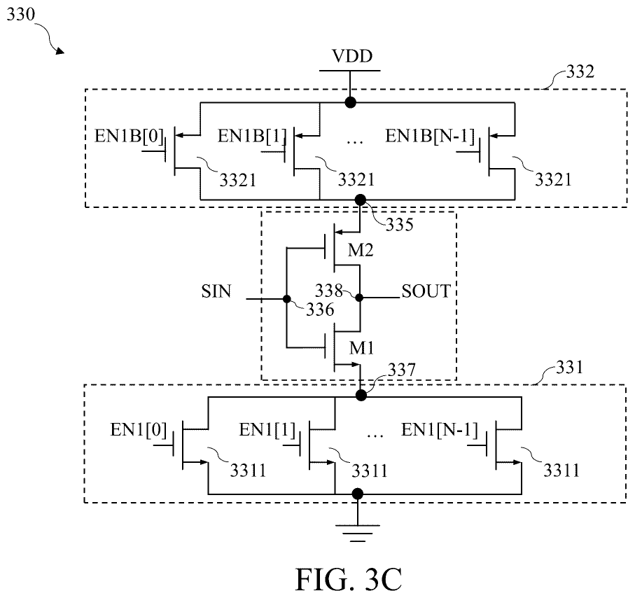

FIG. 3A is a schematic diagram of a deskew circuit in accordance with some embodiments.

In some embodiments, the deskew circuits 211 and 212 in FIG. 2 may each be implemented using the deskew circuit 300A shown in FIG. 3A. The deskew circuit 300A is configured to deskew the delay time of an input signal DSKIN to generate an output signal DSKOUT. In some embodiments, the deskew circuit 300A includes N1 stages of inverters 302 connected in series (e.g., a cascaded structure), where N1 is a positive even number. The inverter 302 in each stage is coupled to the power supply voltage VDD through an upper adjustable resistor RU, and coupled to the ground voltage through a lower adjustable resistor RL. In some embodiments, each stage has an individual control signal for adjusting the resistances of the upper adjustable resistor RU and the lower adjustable resistor RL simultaneously (i.e., the upper adjustable resistor RU and the lower adjustable resistor RL in each stage share the same control signal).

It should be noted that different control signals are used to adjust the resistances of the upper adjustable resistor RU and the lower adjustable resistor RL in respective stages, thereby adjusting the delay of the input signal DSKIN. Additionally, the deskew circuits 211 and 212 can adjust the delay of the input clock signals ICLK and QCLK separately using respective control signals, thereby aligning the deskewed clock signals ICLK and QCLK.

FIG. 3B is a diagram illustrating a portion of the deskew circuit in FIG. 3A.

In some embodiments, portion 320 shown in FIG. 3A is illustrated in FIG. 3B. Portion 320 includes two stages of inverters 302 connected in series. Additionally, a parasitic capacitance Cpar exists between the ground and an output terminal of the inverter 302 at each stage shown in portion 320. This also applies to the inverters in other stages of the deskew circuit 300A.

In some approaches, the deskew circuit is implemented using a plurality of inverters connected in series, and an adjustable capacitor is coupled to an output terminal of each inverter and the ground. The dynamic power consumption P of the deskew circuit in these approaches can be calculated as P=f×CV², where f denotes the frequency of the input clock signal; C denotes the capacitance of the adjustable capacitor in each stage, and V denotes the voltage of the power supply voltage. The deskew circuit in these approaches, which can be regarded as a capacitor-type deskew circuit, exhibits higher power consumption due to its large capacitance.

In contrast, a parasitic capacitance Cpar exists between the ground and an output terminal of the inverter 302 at each stage of the deskew circuit 300A, as shown in FIG. 3B. It should be noted that since the parasitic capacitance Cpar is relatively smaller than the adjustable capacitor, the dynamic power consumption of the deskew circuit 300A is also relatively lower compared to the capacitor-type deskew circuit in the aforementioned approaches. In some embodiments, assuming the use of an equal number of inverter stages, the power consumption of the deskew circuit 300A shown in FIG. 3A is approximately 36% of that of the capacitor-type deskew circuit in the aforementioned approaches (i.e., approximately reducing 64% of power consumption), while maintaining similar delay tuning ranges and latency.

FIG. 3C is a circuit diagram of an inverter stage 330 in FIG. 3B.

In some embodiments, FIG. 3C illustrates the circuit diagram of inverter 302 with its upper adjustable resistor RU and lower adjustable resistor RL within an inverter stage 330 in FIG. 3B. For example, the inverter 302 includes transistors M1 and M2. A source terminal of transistors M2 is coupled to a control circuit 332 at node 335. A source terminal of transistors M1 is coupled to a control circuit 331 at node 337. The inverter 302 is configured to receive an input signal SIN at node 336 and generate an output signal SOUT at node 338.

In some embodiments, the lower adjustable resistor RL is implemented using the control circuit 331 which includes a plurality of first transistors 3311 arranged in parallel. The plurality of first transistors 3311 are controlled by respective bits of the enable signal EN1. Additionally, the upper adjustable resistor RU is implemented using the control circuit 332 which includes a plurality of second transistors 3311 arranged in parallel. The plurality of second transistors 3321 are controlled by respective bits of the enable signal EN1B, which is an inverted version of the enable signal EN1, as depicted in FIG. 3C.

In some embodiments, the number of bits in the high logic state (e.g., “1”) in the enable signal EN1 is programmable, while the number of bits in the low logic state (e.g., “1”) in the enable signal EN1B is also programmable, with at least one transistor 3311 and at least one transistor 3321 being activated for the inverter 302 to work normally. Accordingly, the equivalent resistance of the upper adjustable resistor RU and the lower adjustable resistor RL can be adjusted so as to calibrate the delay of the inverter 302 shown in FIG. 3C.

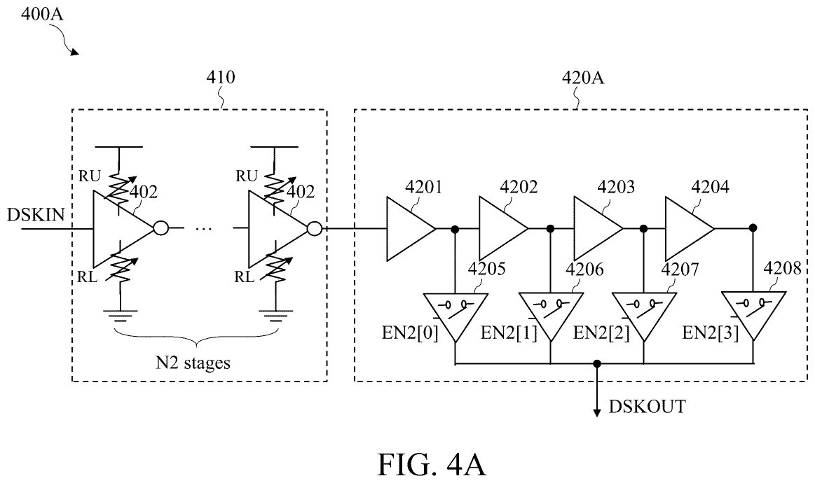

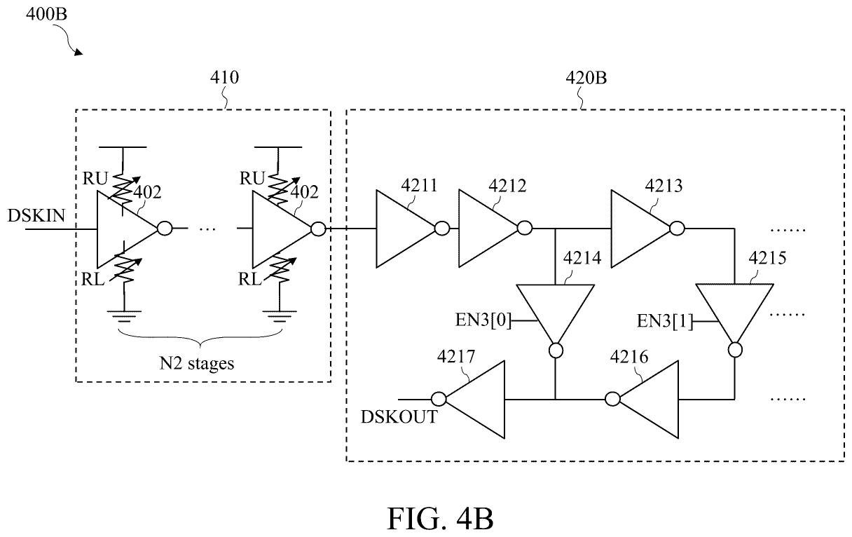

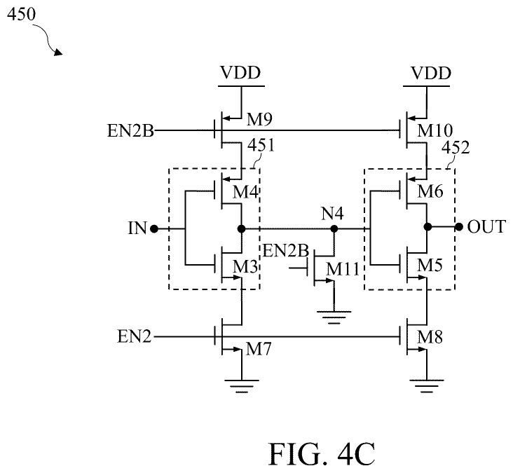

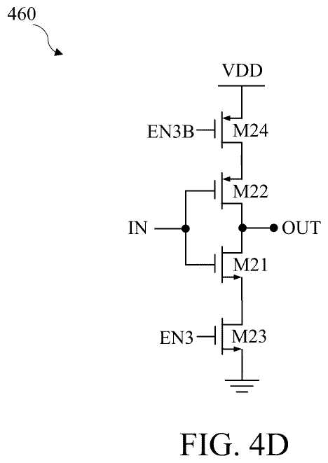

FIG. 4A is a schematic diagram of a deskew circuit in accordance with some embodiments of the present disclosure.

In some embodiments, the deskew circuits 211 and 212 in FIG. 2 may each be implemented using the deskew circuit 400A shown in FIG. 4A. The deskew circuit 400A is configured to deskew the delay time of an input signal DSKIN to generate an output signal DSKOUT.

In some embodiments, the deskew circuit 400A includes a first stage 410 and a second stage 420A, as shown in FIG. 4A. The first stage 410 includes N2 stages of inverters 402 connected in series (e.g., a cascaded structure), where N2 is a positive even number. In some embodiments, the number N1 of stages of inverters 302 in FIG. 3A is greater than the number N2 of stages of inverters 402 in FIG. 4A. In a non-limiting embodiment, the number N1 is 26, while the number N2 is 8.

In some embodiments, the second stage 420A includes buffers 4201 to 4204 and switch-controlled buffers 4205 to 4208. Buffers 4201 to 4204 may each be implemented using two inverters connected in series, indicating that each of buffers 4201 to 4204 constitutes a delay of two inverters. In some embodiments, switch-controlled buffers 4205 to 4208 may each be implemented using two inverters connected in series with enhanced driving capability and controlled by a respective bit of an enable signal EN2[3:0], as depicted in FIG. 4A. Specifically, the first stage 410 and the second stage 420A can be regarded as a fine-tune stage and a coarse tune stage, respectively. For example, the resistances of the upper resistor RU and the lower resistor RL of each stage in the first stage 410 can be tuned by a respective control signal, achieving fine-tuning of the delay time of the input signal DSKIN. In the second stage 420A, one of the switch-controlled buffers 4205 to 4208 is activated, enabling coarse tuning of the delay of the input signal DSKIN on a basis of multiple two-inverter delays. For example, when the respective bit EN2[1] is in the high logic state (e.g., “1”), the switch-controlled buffer 4206 is activated, the remaining switch-controlled buffer 4205, 4207, and 4208 are deactivated at the same time, and the second stage 420A constitutes a delay of three buffers or six inverters, i.e., including buffers 4201 and 4202 and switch-controlled buffer 4206. Accordingly, with a fine-tune stage (e.g., first stage 410) and a coarse-tune stage (e.g., second stage 420A), the control scheme of the deskew circuit 400A shown in FIG. 4A can be simplified, and the latency and area of the deskew circuit 400A can be reduced, thereby improving the power, performance, and area (PPA) of the deskew circuit 400A.

FIG. 4C illustrates a circuit diagram of a switch-controlled buffer in FIG. 4A. In some embodiments, the switch-controlled buffer 450 includes transistors M3 to M10. Transistors M3 and M4 form a first inverter 451, and transistors M5 and M6 form a second inverter 452. Transistors M7 to M9 function as switches. The first inverter 451 and the second inverter 452 are connected in series to form a buffer. Additionally, a source terminal of transistor M4 of first inverter 451 is configured to receive the power supply voltage VDD through transistor M9, while a source terminal of transistor M3 of first inverter 451 is configured to receive the ground voltage through transistor M7. A source terminal of transistor M6 of second inverter 452 is configured to receive the power supply voltage VDD through transistor M10, while a source terminal of transistor M5 of second inverter 452 is configured to receive the ground voltage through transistor M8.

It should be noted that transistors M7 and M8 are controlled by the enable signal EN2, while transistors M9, M10, and M11 are controlled by the enable signal EN2B, which is an inverted version of the enable signal EN2. In some embodiments, when the enable signal EN2 is in the high logic state (e.g., “1”) and the enable signal EN2B is in the low logic state (e.g., “0”), transistors M7 to M10 are activated, and transistor M11 is deactivated, enabling the switch-controlled buffer 450 to work normally and provide a delay of two inverters. Conversely, when the enable signal EN2 is in the low logic state (e.g., “0”) and the enable signal EN2B is in the high logic state (e.g., “1”), transistors M7 to M10 are deactivated, and transistor M11 is activated, pulling down the voltage at node N4 to the ground and disabling the switch-controlled buffer 450.

FIG. 4B is a schematic diagram of another deskew circuit in accordance with some embodiments of the present disclosure.

In some embodiments, the deskew circuits 211 and 212 in FIG. 2 may each be implemented using the deskew circuit 400B shown in FIG. 4B. Additionally, the deskew circuit 400B shown in FIG. 4B is similar to the deskew circuit 400A shown in FIG. 4A, with the difference being that the deskew circuit 400B includes a second stage 420B different from the second stage 420A shown in FIG. 4A. For brevity, the second stage 420B includes inverters 4211 to 4217. In particular, inverters 4214 and 4215 are switch-controlled inverters, the details thereof will be described with reference to FIG. 4D.

In some embodiments, the switch-controlled inverter 4214 is coupled between an output terminal of inverter 4212 and an input terminal of inverter 4217. The switch-controlled inverter 4215 is coupled between an output terminal of inverter 4213 and an input terminal of inverter 4216. Switch-controlled inverters 4214 and 4215 are controlled by respective bits EN3[0] and EN3[1] of the enable signal EN3. For example, when the bit EN3[0] is 1 and the bit EN3[1] is 0, inverter 4214 is activated, and inverter 4215 is deactivated. At this time, the inverter chain within the second stage 420B is through inverters 4211, 4212, 4214, and 4217 in sequence to generate the output signal DSKOUT, there providing a delay of four inverters. When the bit EN3[0] is 0 and the bit EN3[1] is 1, inverter 4215 is deactivated, and inverter 4215 is activated. At this time, the inverter chain within the second stage 420B is through inverters 4211, 4212, 4213, 4215, 4216, and 4217 in sequence to generate the output signal DSKOUT, thereby providing a delay of 6 inverters. It should be noted the second stage 420B can include more inverter stages connected in a manner similar to the arrangement of inverters 4213, 4215, and 4216, and the delay of the inverter chain within the second stage 420B can be controlled by respective bits of the enable signal EN3.

FIG. 4D is a circuit diagram of a switch-controlled inverter in FIG. 4B. In some embodiments, the switch-controlled inverters 4214 and 4215 may each be implemented using the switch-controlled inverter 460 shown in FIG. 4D. The switch-controlled inverter 460 includes transistors M21 to M24, as depicted in FIG. 4D. For example, transistors M21 and M22 form an inverter, and transistors M23 and M24 functions as switches. A source terminal of transistors M22 is configured to receive the power supply voltage VDD through transistor M24. A source terminal of M21 is configured to receive the ground voltage through transistor M23. Additionally, transistor M23 is controlled by the enable signal EN3, while transistor M24 is controlled by the enable signal EN3B, which is an inverted version of the enable signal EN3.

In some embodiments, when the enable signal EN3 is in the high logic state (e.g., “1”) and the enable signal EN3B is in the low logic state (e.g., “0”), transistors M23 and M24 are activated, enabling the switch-controlled inverter 460 to work normally. When the enable signal EN3 is in the low logic state (e.g., “0”) and the enable signal EN3B is in the high logic state (e.g., “1”), transistors M23 and M24 are deactivated, disabling the switch-controlled inverter 460.

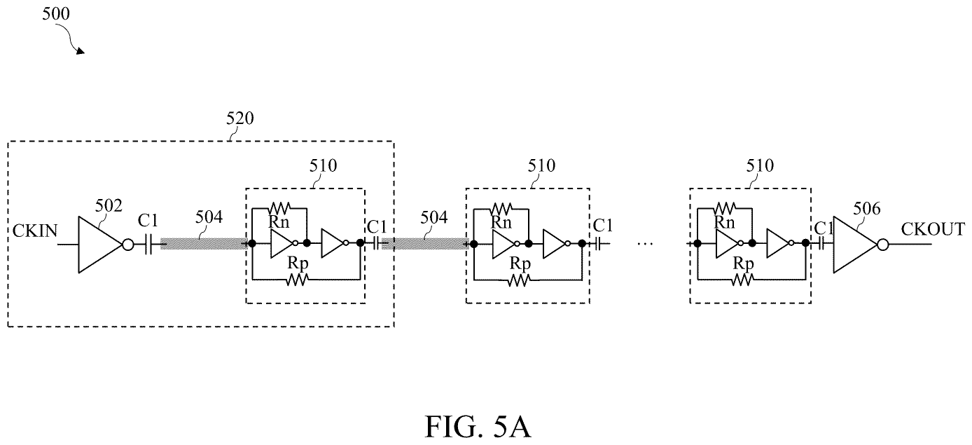

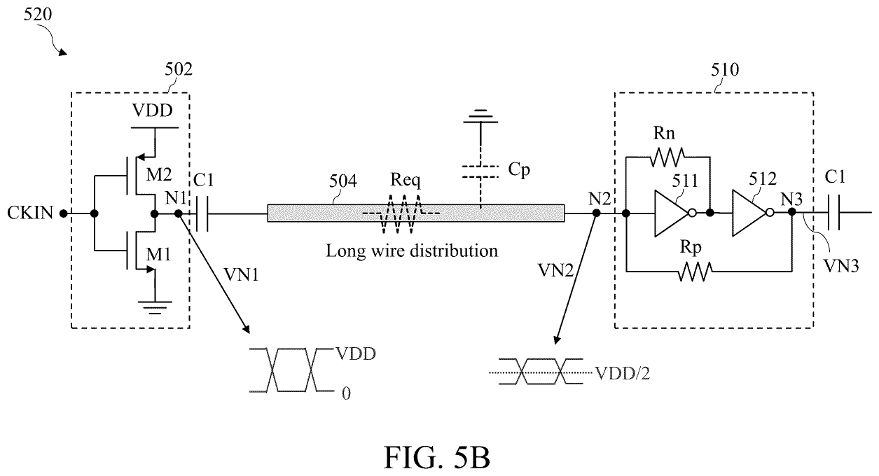

FIG. 5A is a circuit diagram of a clock tree in accordance with some embodiments.

In some embodiments, the clock tree 203 shown in FIG. 2 may be implemented using the clock tree 500 shown in FIG. 5A. For brevity, a serial connection of AC-coupled buffers, such as inverters 502 and 506 and latches 510, is shown in the clock tree 500. Additionally, each of inverters 502 and 506 and latches 510 can be regarded as a clock buffer with a respective capacitor C1 coupled to its output terminal, as depicted in FIG. 5A.

In some embodiments, clock tree 500 is configured to distribute an input clock signal CKIN from a clock source to obtain an output clock signal CKOUT at a clock leaf (e.g., output terminal of inverter 506) along a long clock routing path, which includes multiple conductive wire segments 504. In some embodiments, the direct-current (DC) component of the output voltage of inverter 502 can be isolated from the input terminal of the latch 510 by the corresponding capacitor C1 coupled to the output terminal of inverter 502, while the alternating-current (AC) component of the output voltage of inverter 502 can pass through the corresponding capacitor C1. Similarly, the DC component of the output voltage of a latch 510 can be isolated from the input terminal of a subsequent latch 510 by the corresponding capacitor C1, while the AC component of the latch 510 can pass through the corresponding capacitor C1. Accordingly, each of inverters 502 and 506 and latches 510 can also be regarded as an AC-coupled buffer. In some embodiments, the capacitors C1 in clock tree 500 may be fabricated by the back-end-of-line (BEOL) process. Further details of clock tree 500 are described with reference to FIG. 5B.

FIG. 5B is a circuit diagram of portion 520 in the clock tree 500 in FIG. 5A.

In some embodiments, inverter 502 includes transistors M1 and M2. A gate terminal of transistor M1 is configured to receive the input clock signal CKIN. A first source/drain (S/D) terminal of transistor M1 is coupled to node N1. A second S/D terminal of transistor M2 is configured to receive a ground voltage. A gate terminal transistor M2 is configured to receive the input clock signal CKIN. A first S/D terminal of transistor M2 is configured to receive the power supply voltage VDD. A second S/D terminal of transistor M2 is coupled to node N1.

In some embodiments, the voltage swing range of the voltage at node N1 is between the ground voltage (e.g., 0V) and the power supply voltage VDD. Capacitor C1 corresponding to inverter 502 includes a first terminal coupled to node N2, and a second terminal coupled to a conductive wire segment 504. It should be noted that the conductive wire segment 504 may have a long wire distribution with an equivalent resistance Req. Additionally, a parasitic capacitance Cp exists between the conductive wire segment 504 and the ground. Since the parasitic capacitance Cp and capacitor C1 are connected in series, the equivalent capacitance of capacitor C1 and parasitic capacitance Cp is reduced, reducing the capacitance loading of the power supply voltage VDD. Accordingly, the dynamic power consumption (i.e., P=f×CV²) of inverter 502 can be reduced.

In some embodiments, the voltage swing (i.e., AC component) of the voltage N1, which is inverted from the input clock signal CKIN by inverter 502, is transmitted to node N2 through the conductive wire segment 504. The capacitor C1 and parasitic capacitance Cp may serve as a voltage divider by dividing the voltage VN1 to obtain the voltage VN2 at node N2 (e.g., VN2=VN1*Cp/(C1+Cp)). This indicates that the voltage at node N1 has the full voltage swing range from VDD to 0V, while the voltage at node N2 has a reduced or smaller voltage swing range centered at a particular DC voltage (e.g., VDD/2), depending on the capacitance values of capacitor C1 and parasitic capacitance Cp. In some embodiments, latch 510 may function as a clock receiver and driver. The latch 510 may include inverters 511 and 512, and feedback resistors Rn and Rp. The feedback resistor Rn is coupled between an input terminal (e.g., node N2) and an output terminal of inverter 511. The feedback resistor Rp is coupled between node N2 and an output terminal (e.g., node N3) of inverter 512. Accordingly, the latch 510 can amplify the voltage VN2 at node N2 to generate the voltage VN3 at node N3. It should be noted that another capacitor C1 is coupled to the output terminal (e.g., node N3) of latch 510 to isolate the DC component of voltage VN3. The operations of subsequent latches 510 in FIG. 5A can be derived in a similar manner described above, and thus the details thereof will not be repeated here. Additionally, referring to FIG. 5A, inverter 506 is coupled to the capacitor C1 corresponding to latch 510 in the last stage to convert the voltage with the half voltage swing range at the output terminal of latch 510 to the output clock signal CKOUT with a full voltage swing range.

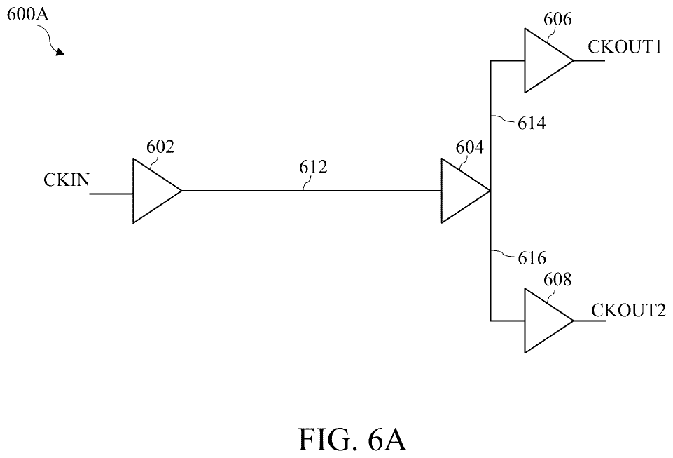

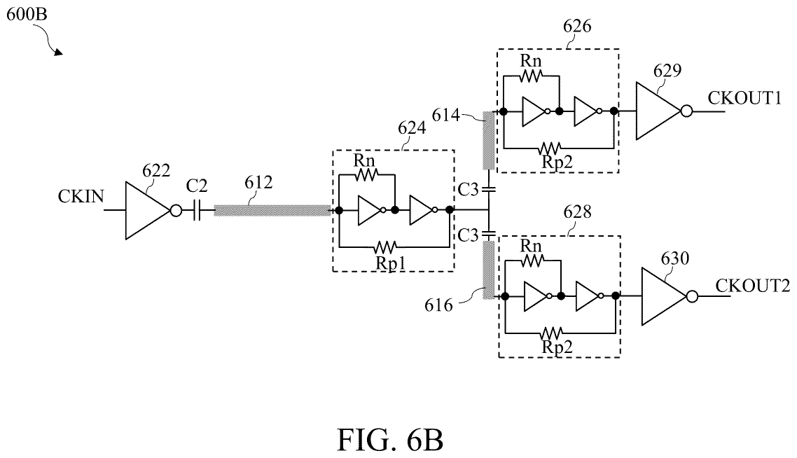

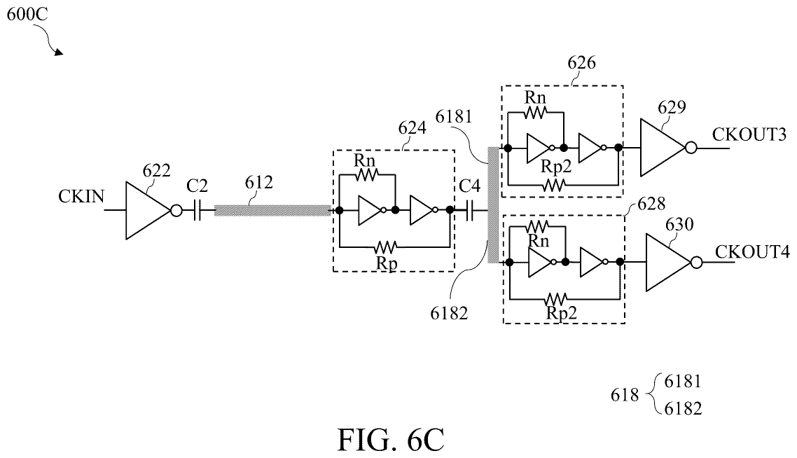

FIG. 6A is a diagram illustrating distribution of a clock tree in accordance with some embodiments.

In some embodiments, clock tree 203 shown in FIG. 2 may be implemented using the fan-out structure of clock tree 600A shown in FIG. 6A. Clock tree 600A includes clock buffers 602, 604, 606, and 608. Clock buffers 602 and 604 may have a higher driving strength than clock buffers 606 and 608. Clock buffers 606 and 608 can be regarded as clock leaves of clock tree 600A. Clock buffer 602 is configured to transmit the input clock signal CKIN to clock buffer 604 through the conductive wire segment 612. Clock buffer 604 is configured to transmit the input clock signal CKIN to clock buffers 606 and 608 through conductive wire segments 614 and 616, thereby obtaining the clock signals CKOUT1 and CKOUT2 at the output terminal of the clock buffers 606 and 608, respectively.

FIG. 6B is a schematic diagram illustrating a first configuration of the clock tree in FIG. 6A.

In some embodiments, a circuit implementation of clock tree 600A in FIG. 6A is shown by clock tree 600B in FIG. 6B. For purposes of description, clock buffer 602 is implemented using inverter 622, and clock buffers 604, 606, and 608 are implemented using respective latches 624, 626, and 628, respectively, as depicted in FIG. 6B. The arrangement of inverter 622, capacitor C2, conductive wire segment 612 and latch 624 shown in FIG. 6B is similar to the scenario shown in FIG. 5B, and thus the details thereof are not repeated here. For purposes of description, the length of the conductive wire segment 612 is approximately 100 μm. A first branch and a second branch extends from the output terminal of latch 624 to latches 626 and 628 through conductive wire segments 614 and 616, respectively. Additionally, the conductive wire segments 614 and 616 have a length of approximately 50 μm, which is half length of the conductive wire segment 612.

In some embodiments, a capacitor C3 is disposed on the first branch and the second branch to isolate the input terminals of latches 626 and 628 from the DC component of the voltage at the output terminal of latch 624. In some non-limiting embodiments, the capacitance of capacitor C2 is approximately 8 fF, and the capacitance of capacitors C3 is approximately 4 fF. It should be noted that since latch 624 is designed to have a higher driving strength than latches 626 and 628, the feedback resistor Rp1 used in latch 624 differs from the feedback resistors Rp2 used in latches 626 and 628, such as Rp2>Rp1. In clock tree 600B shown in FIG. 6B, the voltage at the input terminal of latch 626 is isolated from the voltage at the output terminal of latch 624 and the voltage at the input terminal of latch 628. Similarly, the voltage at the input terminal of latch 628 is isolated from the voltage at the output terminal of latch 624 and the voltage at the input terminal of latch 626. This indicates that an isolated DC fan-out structure is used in clock tree 600B.

It should be noted that an inverter 629 is disposed at the output terminal of latch 626 to ensure that the phase of the output clock signal CKOUT1 aligns with that of the input signal CKIN. Similarly, an inverter 630 is disposed at the output terminal of latch 628 to ensure that the phase of the output clock signal CKOUT2 aligns with that of the input signal CKIN. The circuit structure of clock tree 600B shown in FIG. 6B can be extend to more stages, such as 6 stages to achieve 64 clock leaves for respective receiver circuits 112 in 64 data lanes shown in FIG. 2. Referring to FIG. 2, it should be noted that the input clock signals I_RXCKP and I_RXCKN pass through respective clock trees 203 to generate 64 sets of in-phase clock signal ICLK and quadrature clock signal QCLK, and each set is for each receiver circuit 112 in the respective data lane among 64 data lanes.

FIG. 6C is a schematic diagram illustrating a second configuration of the clock tree in FIG. 6A.

In some embodiments, a circuit implementation of clock tree 600A in FIG. 6A is shown by clock tree 600C in FIG. 6C. The arrangement of inverter 622, capacitor C2, conductive wire segment 612 and latch 624 shown in FIG. 6C is similar to the scenario shown in FIG. 5B, and the details thereof are not repeated here. For purposes of description, the length of the conductive wire segment 612 is approximately 100 μm. It should be noted that a first terminal of capacitor C4 is coupled to the output terminal of latch 624, and a first branch and a second branch extends from a second terminal of capacitor C4 to latches 626 and 628 through conductive wire segments 6181 and 6182, respectively, as depicted in FIG. 6C. The conductive wire segments 6181 and 6182 can be collectively regarded as a conductive wire segment 618. Additionally, the conductive wire segments 614 and 616 have a length of approximately 50 μm, indicating that the conductive wire segment 618 has an overall length of approximately 100 μm.

In some embodiments, capacitor C4 is between the output terminal of latch 624 and conductive wire segment 618 to isolate the input terminals of latches 626 and 628 from the DC component of the voltage at the output terminal of latch 624. In some non-limiting embodiments, the capacitance of capacitors C2 and C4 is approximately 8 fF. It should be noted that due to latch 624 is designed to have a higher driving strength than latches 626 and 628, the feedback resistor Rp1 used in latch 624 differs from the feedback resistors Rp2 used in latches 626 and 628, such as Rp2>Rp1. In clock tree 600C shown in FIG. 6C, the voltage at the input terminal of latch 626 is isolated from the voltage at the output terminal of latch 624. Similarly, the voltage at the input terminal of latch 628 is isolated from the voltage at the output terminal of latch 624. However, the input terminals of latches 626 and 628 share the same DC component because they are electrically connected through the conductive wire segment 618. This indicates that a share DC fan-out structure is used in clock tree 600C.

Similar to FIG. 6B, inverter 629 is disposed at the output terminal of latch 626 to ensure that the phase of the output clock signal CKOUT3 aligns with that of the input signal CKIN. Similarly, inverter 630 is disposed at the output terminal of latch 628 to ensure that the phase of the output clock signal CKOUT4 aligns with that of the input signal CKIN. Additionally, the circuit structure of clock tree 600C shown in FIG. 6C can be extend to more stages, such as 6 stages to serve as 64 clock leaves for respective receiver circuits 112 in 64 data lanes shown in FIG. 2. Referring to FIG. 2, it should be noted that the input clock signals I_RXCKP and I_RXCKN pass through respective clock trees 203 to generate 64 sets of in-phase clock signal ICLK and quadrature clock signal QCLK, and each set is for each receiver circuit 112 in the respective data lane among 64 data lanes.

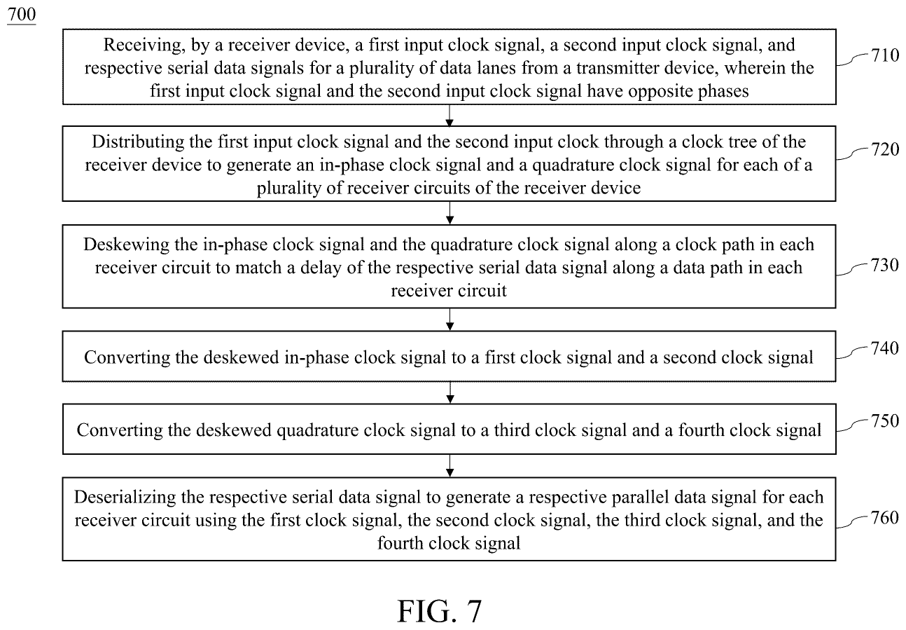

FIG. 7 is flowchart of a method for operating a receiver device in accordance with some embodiments. Please refer to FIGS. 2 and 7 simultaneously. The sequence in which the operations of method 700 are depicted in FIG. 7 is for illustration only; the operations of method 700 are capable of being executed in sequences that differ from that depicted in FIG. 7. It is understood that additional operations may be performed before, during, and/or after the method 700 depicted in FIG. 7, and that some other processes may only be briefly described herein.

At operation 710, a first input clock signal, a second input clock signal, and respective serial data signals for a plurality of data lanes are received by a receiver device (e.g., semiconductor die 200 shown in FIG. 2) from a transmitter device, wherein the first input clock signal and the second input clock signal have opposite phases. In some embodiments, the first input clock signal, the second input clock signal, and the respective serial data signals may refer to the input clock signals I_RXCKP, I_RXCKN, and input serial data signal I_RXDATA[63:0].

At operation 720, the first input clock signal and the second input clock are distributed through a clock tree of the receiver device to generate an in-phase clock signal and a quadrature clock signal for each of a plurality of receiver circuits of the receiver device. In some embodiments, the receiver device (e.g., semiconductor die 200) includes a plurality of receiver circuits 112, as depicted in FIG. 2. The receiver device includes a clock tree 203 configured to distribute the first input clock signal and the second input clock signals to generate the in-phase clock ICLK and the quadrature clock signal QCLK.

At operation 730, the in-phase clock signal and the quadrature clock signal are deskewed along a clock path in each receiver circuit to match a delay of the respective serial data signal along a data path in each receiver circuit. In some embodiments, the deskew circuits 211 and 212 are disposed within each receiver circuit 112, and they are configured to deskew the in-phase clock signal ICLK and the quadrature clock signal QCLK for alignment. It should be noted that no deskew circuit is disposed prior to the clock tree 203, or prior to each receiver circuit 112.

At operation 740, the deskewed in-phase clock signal is converted to a first clock signal and a second clock signal. In some embodiments, the deskewed in-phase clock signal 2101 pass through the duty cycle corrector 213 and the single-to-differential circuit 215 to generate the first clock signal P0 and the second clock signal P180 have opposite phases.

At operation 750, the deskewed quadrature clock signal is converted to a third clock signal and a fourth clock signal. In some embodiments, the deskewed quadrature clock signal 2102 pass through the duty cycle corrector 214 and the single-to-differential circuit 216 to generate the third clock signal P90 and the fourth clock signal P270 have opposite phases. It should be noted that the operations 740 and 750 can be performed concurrently along two different clock paths for the in-phase clock signal ICLK and the quadrature clock signal QCLK.

At operation 760, the respective serial data signal is deserialized to generate a respective parallel data signal for each receiver circuit using the first clock signal, the second clock signal, the third clock signal, and the fourth clock signal. In some embodiments, the deserializer 226 includes a set of SAFFs 2261 to latch the delayed data signal 2241 at the rising edges of the first clock signal, the second clock signal, the third clock signal, and the fourth clock signal to generate a set of latched data signals. In some embodiments, the demultiplexer 2262 is a 4-to-8 demultiplexer operating in conjunction with the four SAFFs 2261, enabling the deserializer 226 to perform 1:2 demultiplexing or deserializing to generate a parallel data signal. In some embodiments, the demultiplexer 2262 can support a larger demultiplexing ratio, thereby achieving a higher demultiplexing rate of the deserializer 226.

An aspect of the present disclosure provides a receiver circuit which includes a clock calibration circuit, an amplifier, a delay chain, and a deserializer. The clock calibration circuit is configured to receive a first input clock signal and a second input clock signal in opposite phases from a clock tree, convert the first input clock signal to a first clock signal and a second clock signal, and convert the second input clock signal to a third clock signal and a fourth clock signal. The amplifier is configured to amplify a serial data signal received from a transmitter device. The delay chain is configured to delay the amplified serial data signal to generate a delayed data signal. The deserializer includes a set of sense-amplifier flip-flops and a demultiplexer. The set of sense-amplifier flip-flops is configured to latch the delayed data signal to generate a set of latched data signals in response to rising edges of the first clock signal, the second clock signal, the third clock signal, and the fourth clock signal. The demultiplexer is configured to demultiplex the set of latched data signals to generate a parallel data signal.

Another aspect of the present disclosure provides a receiver circuit which includes a first clock path, a second clock path, and a data path. The first clock path is configured to receive a first input clock signal from a transmitter device and convert the first input clock signal to a first clock signal and a second clock signal having opposite phases. The second clock path is configured to receive a second input clock signal from the transmitter device and convert the second input clock signal to a third clock signal and a fourth clock signal having opposite phases. The data path includes an amplifier, a delay chain, and a deserializer. The amplifier is configured to amplify a serial data signal received from a transmitter device. The delay chain is configured to delay the amplified serial data signal to generate a delayed data signal. The deserializer is configured to latch the delayed data signal to obtain a set of latched data signals in response to rising edges of the first clock signal, the second clock signal, the third clock signal, and the fourth clock signal, and demultiplex the set of latched data signals to generate a parallel data signal.

Yet another aspect of the present disclosure provides a method. The method includes the following steps: receiving, by a receiver device, a first input clock signal, a second input clock signal, and respective serial data signals for a plurality of data lanes from a transmitter device, wherein the first input clock signal and the second input clock signal have opposite phases; distributing the first input clock signal and the second input clock through a clock tree of the receiver device to generate an in-phase clock signal and a quadrature clock signal for each of a plurality of receiver circuits of the receiver device; deskewing the in-phase clock signal and the quadrature clock signal along a clock path in each receiver circuit to match a delay of the respective serial data signal along a data path in each receiver circuit; converting the deskewed in-phase clock signal to a first clock signal and a second clock signal; converting the deskewed quadrature clock signal to a third clock signal and a fourth clock signal; and deserializing the respective serial data signal to generate a respective parallel data signal for each receiver circuit using the first clock signal, the second clock signal, the third clock signal, and the fourth clock signal.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A receiver circuit, comprising:
a clock calibration circuit, configured to receive a first input clock signal and a second input clock signal in opposite phases from a clock tree, convert the first input clock signal to a first clock signal and a second clock signal, and convert the second input clock signal to a third clock signal and a fourth clock signal;
an amplifier, configured to amplify a serial data signal received from a transmitter device;
a delay chain, configured to delay the amplified serial data signal to generate a delayed data signal; and
a deserializer, comprising:
a set of sense-amplifier flip-flops, configured to latch the delayed data signal to generate a set of latched data signals in response to rising edges of the first clock signal, the second clock signal, the third clock signal, and the fourth clock signal; and
a demultiplexer, configured to demultiplex the set of latched data signals to generate a parallel data signal.

2. The receiver circuit of claim 1, wherein the first input clock signal is an in-phase clock signal, and the second input clock signal is a quadrature clock signal.

3. The receiver circuit of claim 2, wherein the clock calibration circuit comprises:
a first deskew circuit, a first duty cycle corrector, and a first single-to-differential circuit along a first clock path receiving the first input clock signal; and
a second deskew circuit, a second duty cycle corrector, and a second single-to-differential circuit along a second clock path receiving the second input clock signal.

4. The receiver circuit of claim 3, wherein the first deskew circuit is configured to operate in conjunction with the second deskew circuit to align the first input clock signal and the second input clock signal.

5. The receiver circuit of claim 4, wherein the first duty cycle corrector is configured to correct a duty of the deskewed first input clock signal with a predetermined duty to generate a first duty-corrected clock signal, and the second duty cycle corrector is configured to correct a duty of the deskewed second input clock signal with the predetermined duty to generate a second duty-corrected clock signal.

6. The receiver circuit of claim 5, wherein:
the first single-to-differential circuit is configured to convert the first duty-corrected clock signal to the first clock signal and the second clock signal;
the second single-to-differential circuit is configured to convert the second duty-corrected clock signal to the third clock signal and the fourth clock signal; and
the first clock signal, the third clock signal, the second clock signal, and the fourth clock signal have quadrature phases of 0 degrees, 90 degrees, 180 degrees, and 270 degrees, respectively.

7. The receiver circuit of claim 5, wherein the set of sense-amplifier flip-flops (SAFF) comprises a first SAFF, a second SAFF, a third SAFF, and a fourth SAFF configured to latch the delayed data signal to generate a first latched data signal, a second latched data signal, a third latched data signal, and a fourth latched data signal among the set of latched data signals in response to rising edges of the first clock signal, the third clock signal, the second clock signal, and the fourth clock signal, respectively.

8. The receiver circuit of claim 4, wherein:
each of the first deskew circuit and the second deskew circuit comprises a plurality of stages connected in series;
each stage having an inverter with an upper adjustable resistor and a lower adjustable resistor; and
the inverter in each stage is configured to receive a power supply voltage through the upper adjustable resistor, and receive a ground voltage through the lower adjustable resistor.

9. The receiver circuit of claim 8, wherein:
the lower adjustable resistor is implemented using a plurality of first transistors arranged in parallel;
the upper adjustable resistor is implemented using a plurality of second transistors arranged in parallel;
the plurality of first transistors are controlled by respective bits of a first enable signal;
the plurality of second transistors are controlled by respective bits of a second enable signal; and
the second enable signal is an inverted version of the first enable signal.

10. The receiver circuit of claim 8, wherein:
each of the first deskew circuit and the second deskew circuit further comprises a plurality of buffers connected in series, with an output terminal of each buffer being coupled to an output terminal of the first deskew circuit and the second deskew circuit through a respective a switch-controlled buffer, which is controlled by a respective bit of an enable signal.

11. The receiver circuit of claim 10, wherein:
the respective switch-controlled buffer corresponding to each buffer comprises a first inverter and a second inverter connected in series;
the first inverter is configured to receive a power supply voltage through a first switch, and receive a ground voltage through a second switch;
the second inverter is configured to receive the power supply voltage through a third switch, and receive the ground voltage through a fourth switch; and
a voltage pull-down device is coupled between an output terminal of the first inverter and a ground.

12. The receiver circuit of claim 11, wherein:
the second switch and the fourth switch are controlled by a first enable signal;
the first switch, the third switch, and the voltage pull-down device are controlled by a second enable signal, which is an inverted version of the first enable signal;
the second switch, the fourth switch, and the voltage pull-down device comprise a first type of transistors;
the first switch and the third switch comprise a second type of transistors; and
the second type differs from the first type.

13. The receiver circuit of claim 8, wherein:
each of the first deskew circuit and the second deskew circuit further comprises a first delay stage and a second delay stage;
the first delay stage comprises a first inverter, a second inverter, a first switch-controlled inverter, and a third inverter connected series; and
the second delay stage comprises a fourth inverter, a second switch-controlled inverter, and a fifth inverter connected in series.

14. The receiver circuit of claim 13, wherein an input terminal of the fourth inverter is coupled to an output terminal of the second inverter, and an output terminal of the fifth inverter is coupled to an input terminal of the third inverter.

15. The receiver circuit of claim 14, wherein:
each of the first switch-controlled inverter and the second switch-controlled inverter comprises a complementary metal oxide semiconductor (CMOS) inverter, a first switch, and a second switch;
the CMOS inverter is configured to receive a power supply voltage through the first switch, and receive a ground voltage through the second switch;
the second switch and the first switch are controlled by a first enable signal and a second enable signal, respectively; and
the second enable signal is an inverted version of the first enable signal.

16. A receiver circuit, comprising:
a first clock path, configured to receive a first input clock signal from a transmitter device, and convert the first input clock signal to a first clock signal and a second clock signal having opposite phases;
a second clock path, configured to receive a second input clock signal from the transmitter device, and convert the second input clock signal to a third clock signal and a fourth clock signal having opposite phases; and
a data path, comprising:
an amplifier, configured to amplify a serial data signal received from a transmitter device;
a delay chain, configured to delay the amplified serial data signal to generate a delayed data signal; and
a deserializer, configured to latch the delayed data signal to obtain a set of latched data signals in response to rising edges of the first clock signal, the second clock signal, the third clock signal, and the fourth clock signal, and demultiplex the set of latched data signals to generate a parallel data signal.

17. The receiver circuit of claim 16, wherein:
the first input clock signal is an in-phase clock signal, and the second input clock signal is a quadrature clock signal; and
the first clock signal, the third clock signal, the second clock signal, and the fourth clock signal have quadrature phases of 0 degrees, 90 degrees, 180 degrees, and 270 degrees, respectively.

18. The receiver circuit of claim 16, wherein:
a clock tree in each of the first clock path and the second clock path comprises a first inverter, a plurality of latches, and a second inverter connected in sequence;
the clock tree is configured to distribute an input clock signal along the clock path to generate an output clock signal; and
the first inverter is electrically connected to a first latch among the plurality of latches through a first capacitor and a first conductive wire segment.

19. The receiver circuit of claim 18, wherein:
the first latch is electrically connected to a second latch among the plurality of latches through a second capacitor and a second conductive wire segment; and
the second latch is electrically connected to the second inverter through a third capacitor, and configured to generate the output clock signal.

20. A method, comprising:
receiving, by a receiver device, a first input clock signal, a second input clock signal, and respective serial data signals for a plurality of data lanes from a transmitter device, wherein the first input clock signal and the second input clock signal have opposite phases;
distributing the first input clock signal and the second input clock through a clock tree of the receiver device to generate an in-phase clock signal and a quadrature clock signal for each of a plurality of receiver circuits of the receiver device;
deskewing the in-phase clock signal and the quadrature clock signal along a clock path in each receiver circuit to match a delay of the respective serial data signal along a data path in each receiver circuit;
converting the deskewed in-phase clock signal to a first clock signal and a second clock signal;
converting the deskewed quadrature clock signal to a third clock signal and a fourth clock signal; and
deserializing the respective serial data signal to generate a respective parallel data signal for each receiver circuit using the first clock signal, the second clock signal, the third clock signal, and the fourth clock signal.
